(19) United States
(12) Patent Application Publication
(10) Pub. No.: US 2011/0254432 A1
(43) Pub. Date: Oct. 20, 2011

(54) SUBSTRATE FOR A FIELD EMITTER, AND METHOD TO PRODUCE THE SUBSTRATE

(76) Inventor: Heinrich Zeininger, Obermichelbach (DE)

(21) Appl. No.: 13/071,804

(22) Filed: Mar. 25, 2011

(30) Foreign Application Priority Data
Mar. 30, 2010 (DE) 10 2010 013 362.0

(51) Int. Cl. H01J 1/02; B05D 5/12; B82Y 30/00

(52) U.S. Cl. 313/351; 427/77; 977/842; 977/939

(57) ABSTRACT

A substrate for a field emitter suitable for use in computed tomography has a coating with carbon hybrid structures based on the allotropes graphite, graphene and nanotubes. The field emitters are based on graphite layer structures. A substrate for field emitters is achieved for the first time that uses “graphite combs” protruding and aligned essentially perpendicular to the substrate as well as hybrid materials from these combs with CNTs supported between them on a conductive substrate.

### BACKGROUND OF THE INVENTION

1. Field of the Invention

The invention concerns a substrate for a field emitter of the type suitable for use in computed tomography, as well as a method to produce the substrate and use of the substrate, in particular in computer tomography.

2. Description of the Prior Art

The disadvantage of the known field emitters of the type used in computed tomography is the low currents and low mechanical stability associated therewith.

### SUMMARY OF THE INVENTION

An object of the present invention is to provide carbon-based structures with long edges and many peaks in order to enable higher currents and a self-stabilizing, long-term durability (stability) of field electron emitters for use in high vacuum for applications in, among other things, computed tomography.

A general basis of the invention is the insight that aligned CNTs and unfolded carbon graphene or, multislice graphite (<10 graphene layers) (thus graphite structures with slightly angled or partially upright emitter edges), and primarily a combination of these two coatings, are particularly suitable for the high emission currents in field emitters.

The above object is thus achieved in accordance with the invention by a substrate for a field emitter, wherein the substrate is electrically conductive and graphene layer structures are applied thereon, these layer structures protruding like waves from the coating, or the layer structures are aligned at different angles and/or are arranged so as to be upright, at least in portions thereof. Such a substrate is produced in accordance with the invention by application of a dispersion on the substrate and subsequent curing.

A method to produce such graphite layer structures is known from DE 10328342 B4, the content of which is incorporated herein by reference.

Investigation has shown that both graphite layer structures and CNT nanotubes alone show good properties as a coating for field emissions, and in particular have combined CNT/graphene/hybrid systems have synergistic property profiles. Both the electrical emitter properties and the mechanical emitter properties should be increased with CNT, graphite layer structures and hybrid systems produced from these.

Graphite layer structures or graphite films or multiple graphite slices or multiple graphene layer systems; these terms are presently used synonymously and are known from DE 10328342 B4. Assuming thermally reduced graphite oxide, individualized graphenes can be dispersed.

The properties of CNT and graphite layer structures that have both very high aspect ratios are strongly anisotropic. Via modeling it could already be shown that graphite layer structures with columnar CNTs can be assembled into 3D superstructures (“pillared graphene architectures”) that have synergies with electrical conductivity (Literature: Modeling of thermal transport in pillared-graphene architectures, Varshney Vikas; Patnaik Soumya S; Roy Ajit K; Froudakis George; Farmer Barry L.; Materials and Manufacturing Directorate, ACS nano (2010), 4(2), 1153-61).

The properties can be additionally improved by functionalizing the CNT ends and the graphite structures (Electrically Conductive “Alkylated” Graphene Paper via Chemical Reduction of Amine-Functionalized Graphene Oxide Paper by Compton, Owen C.; Dikin, Dmitriy A.; Putz, Karl W.; Brinson, L. Catherine; Nguyen, SonBinh, Department of Chemistry, Northwestern University 2145 Sheridan Road, Evanston, Ill., USA;. Advanced Materials (Weinheim, Germany) (2010), 22(8), 892-896).

CNT graphite layer structure hybrid systems combine the advantages of lengthy edges and peaks, as shown in FIGS. 1 and 2. The mechanically labile CNT tubes are assembled between graphs or, respectively, multiple graphite layers (<10 layers).

The topography in the valleys protects the CNTs, while the emission surface is optimally assembled as alternating edges or layer boundaries (made of graphene or multiple graphite layers) and CNT peaks.

The graphite layer structures can be directly applied on a conductive substrate from aqueous dispersions or hybrid polymer dispersions.

However, to improve the mechanical stability it can also connected with the conductive substrate via a graphite binder layer. The graphite binder is preferably also a good electrical conductor.

The graphene/graphite binder layer is mechanically stable and chemically well connected to the metal substrate. For the vacuum application the systems can be heated to temperatures >400° C. Due to the later use in high vacuum, the coating of graphene/graphite structure and CNT can be thermally baked (heated). All compounds of low molecular weight can thereby be decomposed.

Manufacture and coating with expanded graphite layer structures and CNT:

Graphite multislices (<10 slices) have intrinsic polar functions at the layer edges. In aqueous or aqueous/alcoholic solvents, given reactive graphite edges the graphite multislices can be additionally chemically functionalized by acids (—COOH) or amines (—NH2), for example. The conductivity and adhesive strength at metallic surfaces can be controlled over a very wide range via the functionality of the graphite layer structure.

The metal substrates are coated under normal (room temperature, ambient atmosphere) conditions with typical wet-chemical coating methods—doctoring, immersion, flooding, spraying—and subsequently cured at approximately 150-200° C. Wave-like surface topographies with exposed, raised layer edges with wave crests and valleys and a shown in FIG. 3 thereby result. A stronger connection to the metal substrate can be achieved via the functionalization of the layer edges with polar groups. The layer structures are constructed from individual multiple graphite slice structures, and in part from graphenes (single graphite layers) as well.

Multi-wall or single wall nanotubes can also be introduced and dispersed in the multiple graphite layer dispersions. The formation of CNT/graphite/graphene hybrid layers in the dispersion results via self-organized structuring and the assistance of auxiliary dispersion agents in hybrid polymer dispersions.

The CNTs are advantageously deposited due to the high van der Waals forces at the graphite/graphene edges or bond strongly to the graphite multislice structures.

The CNTs are additionally mechanically stabilized in the shelters of the graphene/graphite valleys. By using the valleys with partially aligned CNTs and/or the CNT arrays at the graphite/graphene edges, the emitter surface is effectively used and enables high emitter currents.

For example, CNTs can be directly, covalently coupled with the protruding graphene or, respectively, multiple graphite layers (<10 graphenes) via acid or amine functionalization, and therefore can be aligned in the direction of the wave crests. The CNT tubes, as a 1D material, can ideally be adapted to the multiple graphite or, respectively, graphene edges or, respectively, surfaces and thus experience a maximum mechanical protection. The aligned CNTs can furthermore be obtained via chemical etching of a slanted tube end. Graphenes or graphite layer structures, as 2D materials, can form, for example, by unrolling of large, contiguous emitter edges or combs. The mechanical stability is then achieved by a multilayer layer design, for example.

### BRIEF DESCRIPTION OF THE DRAWINGS

FIG. 1 schematically illustrates acute tube ends.

FIG. 2 shows long emitter edges given aligned multiple graphite or multiple graphene layer structures.

FIG. 3 shows the surface morphology of the aligned graphite layer structures with CNTs indicated.

### DESCRIPTION OF THE PREFERRED EMBODIMENTS

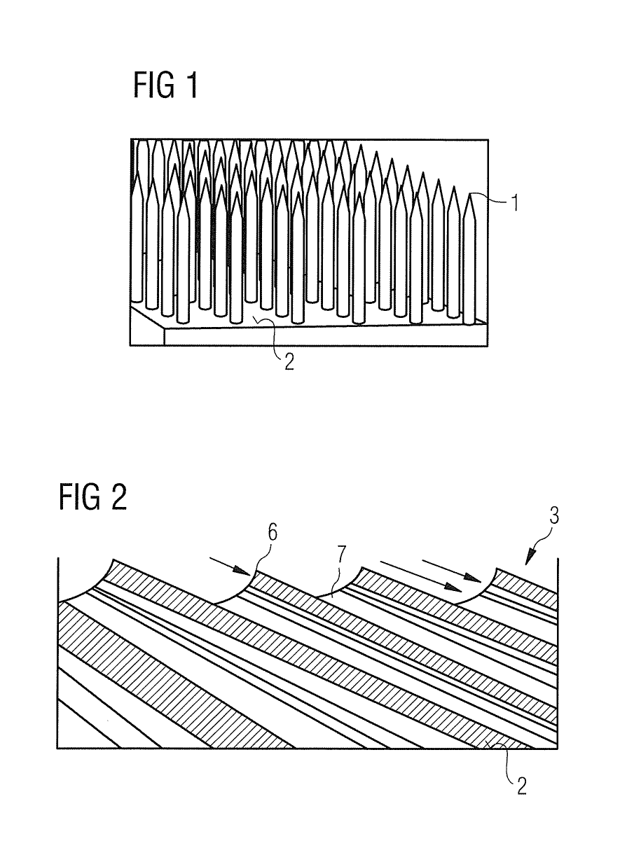

FIG. 1 schematically shows a CNT forest on a conductive surface. The peaks 1 of the CNTs are apparent.

The advantage of the CNTs is that high emitter currents can be emitted at numerous CNT point sources. The bonding of the pure CNTs to metal surfaces can be supported by conductive adhesives. Pure multiple graphite binder layers combine the advantages of high emitter currents, mechanical stability and negligible components of low molecular weight and therefore are particularly well suited for high vacuum applications.

FIG. 2 shows the graphite layer structure 3, wherein the graphite layer is arranged like an unfolded paper or film on the substrate surface 2. The graphite layer structure shows high emitter currents at the long emitter edges 6 or graphene edges. The valleys 7—in which the peaks of the CNTs according to the invention can be arranged according to one embodiment of the invention—lie between the emitter edges 6.

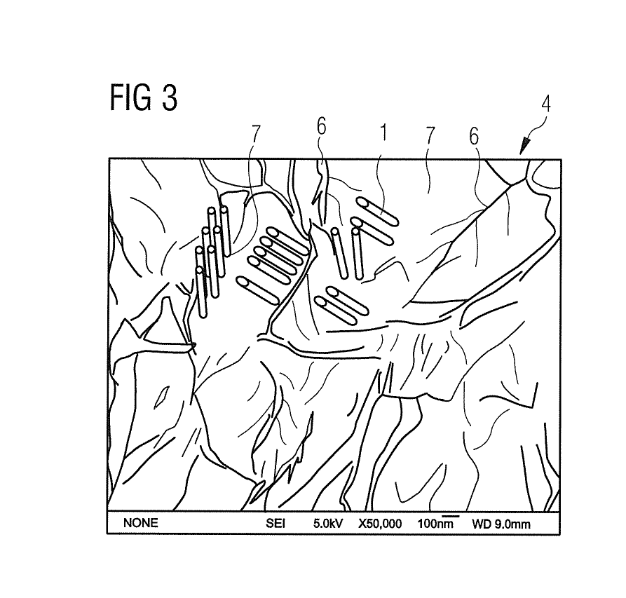

FIG. 3 shows the morphology of a graphite layer structure 4 on a substrate as a photo, wherein the support of the CNTs 1 is indicated by simple line images 5. It is apparent that the CNT emitter peaks are arranged within the valleys 7 and between the emitter edges or emitter combs (clearly arises from the photo) 6.

The invention concerns field emitters on the basis of graphite layer structures. Via the invention a substrate for field emitters is for the first time achieved that uses “graphite combs” protruding and aligned on the substrate as well as hybrid materials made up of these combs with CNTs borne between them on a conductive substrate.

This invention for the first time discloses the significant potential of graphite layer structures and of graphite layer structures/CNT hybrid systems and their application to field emitters. The systems are suitable not only due to the significant electrical durability but also due to mechanical and chemical stability as well as usage possibilities due to targeted derivatization.

The invention concerns a substrate for a field emitter, methods to produce the substrate and use of the substrate, in particular in computer tomography. The substrate has a coating with carbon hybrid structures on the basis of the allotropes graphite, graphene and nanotubes.

The invention concerns field emitters on the basis of graphite layer structures. The substrate for field emitters disclosed herein for the first time uses “graphite combs” protruding and aligned essentially perpendicular to the substrate as well as hybrid materials from these combs with CNTs separated or located between them on a conductive substrate.

Although modifications and changes may be suggested by those skilled in the art, it is the intention of the inventor to embody within the patent warranted hereon all changes and modifications as reasonably and properly come within the scope of his contribution to the art.

I claim as my invention:

1. A substrate assembly for field emitter, comprising:
an electrically conductive substrate;
graphene layer structures applied on said electrically conductive substrate as a coating on said substrate; and
said graphene layer structures comprising a combination of graphene layer structures protruding in a wave-like manner from said coating, and structures standing at a plurality of different non-perpendicular angles, and structures standing substantially erect on said substrate.

2. A substrate as claimed in claim 1 comprising a plurality of aligned carbon nanotubes between said layer structures.

3. A substrate as claimed in claim 1 wherein said graphene layer structures comprise dispersions with expanded graphite and multiple graphite particles.

4. A substrate as claimed in claim 1 wherein said graphene layers structures comprise dispersions of expanded graphite with multiple graphite particles and carbon nanotubes.

5. A method for producing an electrically conductive coating on a substrate, comprising:
under room temperature and ambient atmosphere conditions, coating a substrate with a dispersion of expanded graphite with a wet-chemical coating technique selected from the group consisting of doctoring, immersion, flooding and spraying; and
subsequently curing the dispersion of expanded graphite applied to said substrate in a range between approximately 150° and approximately 200° C., to produce graphene layer structures on said coating comprising a combination of layer structures protruding from the coating in a wave-like manner structures standing a plurality of different non-perpendicular angles, and structures standing substantially erect on said substrate.

6. A method as claimed in claim 5 comprising chemically treating the graphene layer structures after curing.
